(19) United States
(12) Patent Application Publication
(10) Pub. No.: US 2020/0398283 A1
(43) Pub. Date: Dec. 24, 2020

(54) Multi-Layer Lifter For Semi-Autogenous Mills Or Sag Mills

(71) Applicant: ASESORIAS Y SERVICIOS INNOVAXXION SPA, Santiago (CL)

(72) Inventors: Daniel CUCHACOVICH MIKENBERG, Santiago (CL); Pablo SUAREZ LOIRA, Santiago (CL)

(21) Appl. No.: 16/764,365

(22) PCT Filed: Nov. 12, 2018
(86) PCT No.: PCT/CL2018/050109

§ 371 Date: May 14, 2020

(30) Foreign Application Priority Data
Nov. 14, 2017 (CL) 2894-2017

(51) Int. Cl. B02C 17/22; B02C 17/18

(52) U.S. Cl. CPC B02C 17/225; B02C 17/16; B02C 17/1825

(57) ABSTRACT

The invention relates to a multi-layer lifter for semi-autogenous mills or SAG mills with improved durability, made up of: a base formed by a body having a rectangular cross-section, which has a first straight side wall and a second angled side wall; where an angled rectangular portion emerges from the upper half of said angled wall, in which a trapezoidal projection emerges from the lower portion of said base, to fit with the coatings or liners of the inside of the mill; a multi-laminated spring portion which is made up of a plurality of convex curved sheets and a bent straight portion that is located under the angled rectangular portion of said base; and a hollowed-out rubber body, located in the cavity formed by the base and the convex curved sheets.

### TECHNICAL FIELD OF THE INVENTION

The present invention refers to a lifter for semi-autogenous mills, which consists of multiple sheets acting as a spring that accumulates energy in the lower part of the mill and then releases it by pushing the balls and the grinding ore as the mill rotates.

### BACKGROUND OF THE INVENTION

Semi-autogenous mills or SAG mills are machines used in mining plants to grind ore rocks, in order to reduce their size and make them suitable for the subsequent stages of ore processing.

These mills are called “semi-autogenous” because to achieve the ore grinding, the rotating drum, which forms the body of the mill, contains lifter bars, or lifters, that lift the ore during the rotation and drop it in such a way that the rock fractures continuously. This process is called “autogenous effect” since the rock is milled by being impacted on itself. The semi-autogenous principle is characterized by also adding a variable amount of high-hardness steel balls to the ore load, which are also lifted with the load and impact the rock facilitating and accelerating its grinding.

These SAG mills are characterized by their power and size that is greater than the ball mills and by allowing a greater ratio of size reduction for the rocks. In this way, a plant that performs semi-autogenous grinding can simplify its process by going directly from primary crushing to flotation, without using intermediate stages of secondary and tertiary crushing in order to reduce the size of the ore.

Lifters are fundamental elements to lift the ore and, in its design and manufacture, lays the efficiency and grinding capacity of the mill. The existing lifter state of the art describes them as large bars or beams of molten steel that are screwed to the interior of the mill drum and are distributed radially. The height and angle of attack determines the amount of material lifted by them and the height from which it falls. A very high lifter with an angle of attack close to 90° will raise a large amount of material, but it will require huge energy consumption due to the torque needed to move and elevate the grinding material that accumulates in the so-called foot of charge and that takes the form of a kidney during the mill rotation. The pronounced height also implies a large surface of attack on the material, which accelerates its wear.

On the other hand, a very low lifter or with an angle less than 25° will last longer but will lift very little material and will require the mill to turn at a high speed of rotation to achieve grinding, making it very inefficient.

Another condition that determines the lifter operation and duration is characterized by the hardness of the steel with which it is manufactured, which typically is in medium ranges since it must withstand the possible impacts of the steel grinding balls. If the material were a very hard and rigid steel (ideal to withstand the ore abrasion), the lifter could break, thus releasing large fragments of steel that could destroy the mill. For this reason, it is preferable for durability to be sacrificed and for softer steels to be used in the lifters, which typically must be changed every 4 months with the respective cost overruns caused by downtime (around 60 hours per year).

In the state of the art, there have been several attempts to manufacture lifters that overcome the aforementioned problems. For example, US 2014/203129 discloses coating elements, such as lifter bars, that can be used in ore grinding mills. In one example, a lifter bar has an upper elastomeric layer and a lower elastomeric layer, the composition of the upper elastomeric layer being different from that of the lower elastomeric layer. In another example, a lifter bar is made of natural rubber reinforced with carbon black, and has a front face and a protrusion in an upper region of the front face. In an additional example, a lifter bar is made of natural rubber reinforced with carbon black and has a front face geometry such that the face angle is 25° or less during an operating period measured from the time the lifter bar is new to the time the lifter bar height is reduced by a certain amount, for example, by 80%. This document also discloses methods for manufacturing an elastomeric coating element and for grinding ore.

WO 2016/059293 discloses a lifter bar, a method for manufacturing a lifter bar, a method for assembling a lifter bar and a grinding mill comprising multiple lifter bars. The lifter bar comprises a lifter bar body having a wear surface and comprising polyurethane, a reinforced wear plate attached to the body of the lift rod and forming part of the wear surface. The reinforced wear plate comprises metal and a wear surface to form the lifter bar, and a coupling structure provided to the reinforced wear plate for attaching the reinforced wear plate to the lifter bar body. The fixing structure protrudes into the lifter bar body to form a connection with polyurethane.

CL359-2010 discloses a lifter for SAG mills, which decreases its replacement in the mills, which allows the use of both its main face and its rear face. Its main face consists of a steel plate; in the internal part of the rear face, it has a steel core, and in the lower portion, a fixing assembly formed in structural steel, all of it being formed as a monolithic bar by means of rubber joining the steel plate and the fixing assembly together.

None of the prior art documents solves the technical problem of increasing the lifter service life, in addition to reduce the use of energy in a semi-autogenous mill or SAG mill.

### SUMMARY OF THE INVENTION

The present invention solves several of the characteristic problems of lifters since it consists of a body that has no rigid core and whose surface of attack and lift works as a package of multi-laminated springs, which when passing through the base of the mill load kidney (where the largest mass of ore is located) is compressed due to the weight, accumulating energy and minimizing its attack profile. This way, the lifter resistance against the ore load is minimized, thus reducing the abrasion and the mill requirement of torque and extending its service life. In turn, the lifter, which continues to rotate, releases the accumulated energy to the kidney outlet, which is the area where the lift is actually produced and where the load is lower. In this area, the lifter acts as a spring and releases the accumulated energy, thus driving the load to a greater distance than a solid lifter with the same angle of attack would achieve.

Another feature of the filed invention is that, as it consists of a flexible laminar structure, it does not have a solid core, which is replaced by a light elastomeric core whose function is to prevent the accumulation of ore in the lifter interior area not to interfere with the blades compression that act under the spring principle. This elastomeric core is deformed together with the steel plates that make up the attack profile and helps to accumulate and subsequently release the energy that drives the load.

Another characteristic of the laminar lifter is that each of the sheets that form the lifter has the same resistance to wear. Thus, if one of the sheets is worn down, the next sheet that remains in contact with the ore has the same hardness as the previous sheet. That is, the wear resistance does not change as the lifter wears down.

In addition, this setup has the great advantage that this lifter is ostensibly lighter than an equivalent cast lifter.

For all the above elements, this invention allows to increase the energy efficiency of a SAG mill significantly by requiring lower torque and fewer revolutions per minute to keep the same ore lifting behavior than an equivalent mill with cast lifters.

In addition, the present invention will have a longer duration compared to a traditional molten steel lifter by reducing its attack profile when compressed.

### BRIEF DESCRIPTION OF THE DRAWINGS

The accompanying drawings are included to provide further understanding of the invention, and are a part of this description and show one of the preferred embodiments.

FIG. 1 shows a perspective view of the multi-laminar lifter of the present invention.

FIG. 2 shows a perspective view of the multi-laminar lifter with the elastomeric core of the present invention.

FIG. 3 shows a perspective view of the interior of a mill, where the multi-laminar lifter of the present invention is installed.

FIG. 4 shows a perspective view of the interior of a mill, where a plurality of multi-laminar lifters of the present invention is installed.

FIG. 5 shows a perspective view of a row of multi-laminar lifters of the present invention.

FIG. 6 shows a perspective view with an uncompressed multi-laminar lifter and another multi-laminar lifter compressed by a ball to accumulate energy.

FIG. 7 shows a perspective view of one of a SAG mill of the prior art, showing the ore kidney shape and balls with flattened shape.

FIG. 8 shows a cross-sectional view of a SAG mill, showing the ore kidney and balls with the multi-laminar lifters being compressed in the lower part and releasing energy with the ball drive and ore on the upper part of said kidney.

FIG. 9 shows a cross-sectional view of a SAG mill, showing the ore kidney and balls, with the multi-laminar lifters being compressed in the lower part and highlighting the energy release with the ball drive and ore on the upper part of said kidney.

### DESCRIPTION OF THE INVENTION

The present invention refers to a lifter bar, or lifter, for semi-autogenous mills, which consists of multiple sheets acting as a spring that accumulates energy in the lower part of the mill and then releases it by pushing the balls and the milling ore in the upper part as the mill rotates.

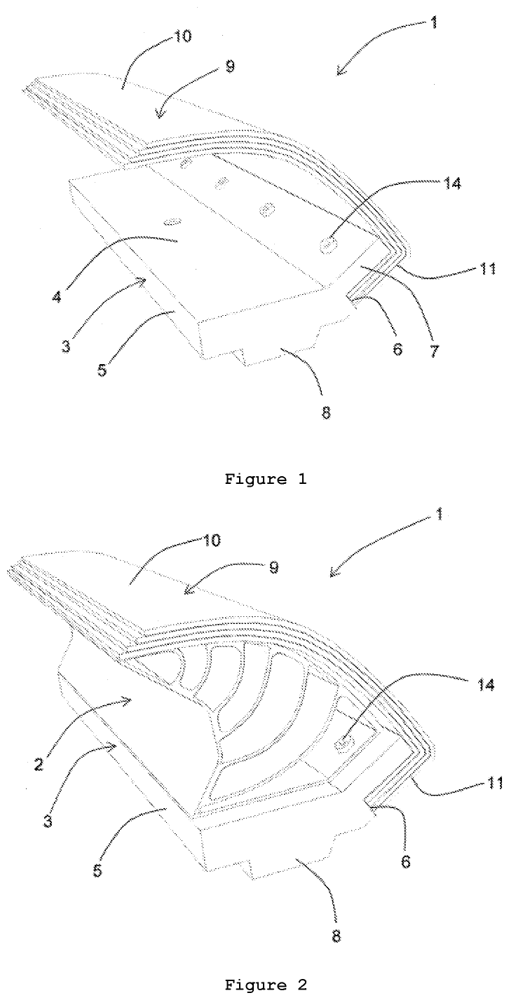

With reference to FIGS. 1-5, a perspective of the multi-layer lifter (1), as well as a portion of the SAG mill that has said multi-layer lifter (1) installed, which consists of a base (3) and a multi-laminar spring (9), consisting of the multiple layers that act as a package spring and that are worn down in layers as its use progresses, is shown.

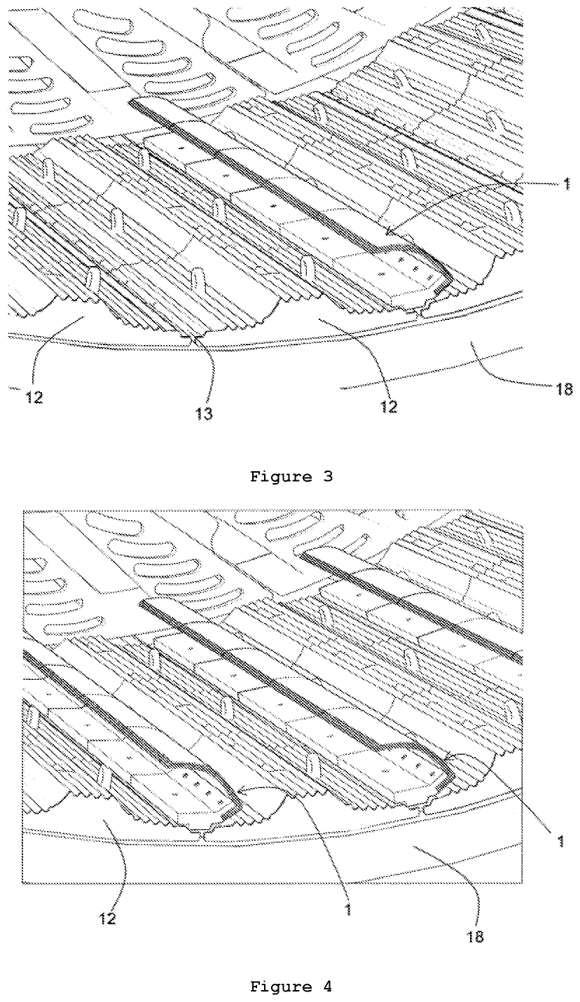

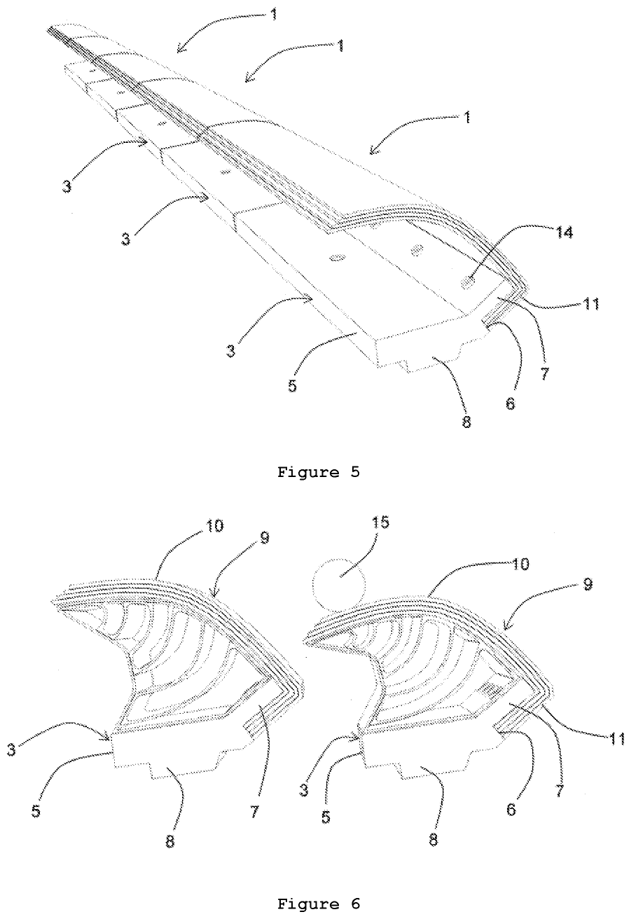

The base (3) consists of a body with a rectangular cross section (4), which has a first straight sidewall (5) and a second angled sidewall (6). From the upper half of said angled wall (6), a rectangular angled portion (7), which has the function of fastening the multiple convex sheets (10) of the straight portion (11) of the multi-laminar spring (9) of the multi-layer lifter (1), arises. From the lower part of the base (3), a trapezoidal projection (8), which fits with the liners (12) inside the mill, thus forming one next to the other inside the mill a trapezoidal cavity (13) so that said trapezoidal projection (8) is fitted, emerges as shown in FIGS. 3 and 4. The base (3) has at least one perforation to join the multi-layer lifter (1) to the mill drum (18). The lifters are placed side by side (as shown in FIG. 5), thus forming a continuous line from the inlet of the mill material to the sorting grills (14), where the material is discharged according to the ore size and the grooves of said grill (see FIGS. 3 and 4).

The multi-laminar spring portion (9) is made up of a multiplicity of curved convex sheets (10) and a bent straight portion (11) which is located under the rectangular angled portion (7) of the base (3), which are joined by bolts and nuts (14). Thus, the multi-laminar spring portion (9) consists of a curved convex portion and a bent straight portion, wherein the latter fits under the angled rectangular portion (7) of the base (3).

The metallic portion, consisting of the base (3) and the curved convex portion of the multi-laminar spring (9), leave a recess that is filled by a hollow rubber body (2), which deforms when the multiplicity of sheets is compressed as a result of the force generated by the ore and the balls (15), as shown in FIG. 6. Indeed, this figure allows to noting the deformation suffered by the hollow rubber body (2) and the curved convex sheets (10) of the multi-laminar spring (9) caused by the weight of the balls (15) and the ore. In addition, the hollow rubber body (2) has the function of filling the void left by the metal portions of the base (3) and the curved convex sheets (10) of the multi-laminar spring (9), thus preventing it from being filled with balls and ore.

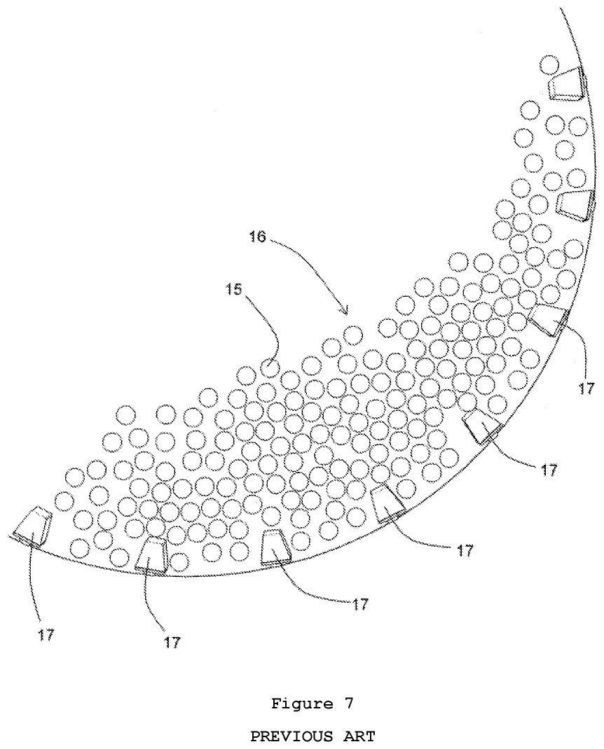

FIGS. 7-9 show the effect produced by the multi-layer lifter (1) as the mill rotates.

FIG. 7 of the prior art shows a mill inside of which there is a plurality of trapezoidal lifters (17), where, as the mill turns, the ore and balls (15) are lifted by them and a kidney of material (16) is generated.

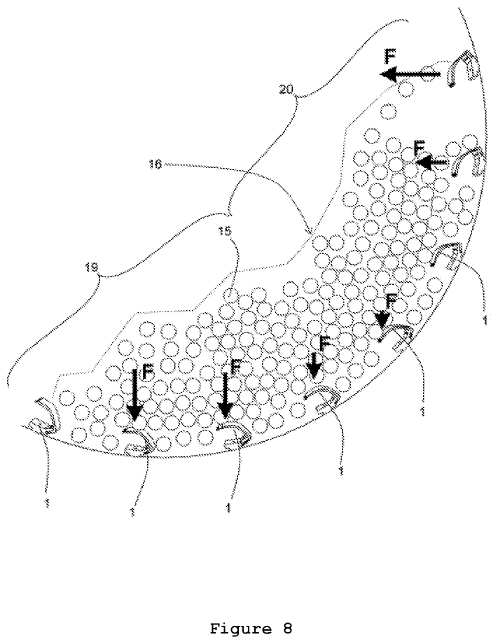

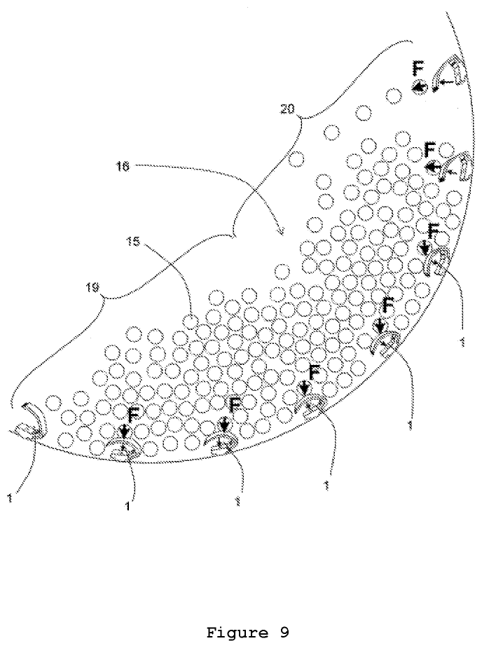

FIGS. 8 and 9 show how the column of balls on the multi-layer lifter (1) generates a compression force F. In FIG. 8, the size of the arrow indicates the magnitude of the force F that is generated in the kidney (16) and that crushes the multi-layer lifters (1), thus initiating the compression of the curved convex blades (10) of the multi-laminar spring (9). In the first lower portion (19) of the kidney (16), the force F is observed to be higher on the multi-layer lifter (1) and decreases as the mill turns. Towards the part of the upper part (20) of the kidney (16), the force is lower, but the curved convex blades (10) of the multi-laminar spring (9) begin to decompress. The difference in strength between one side of the kidney and the other is the force accumulated by the multi-layer lifter (1) to release it as a pulse on the upper part (20) of the kidney (16), thus causing the balls (15) and ore to be propelled towards the center of the mill, as shown in FIG. 9.

According to the above, it is possible to provide the following method of operation of the multi-layer lifter (1):

(a) compressing in the lower part (19) of the kidney (16) a plurality of multi-layer lifters (1) having a multi-laminar spring portion (9) with curved convex sheets (10);

(b) decompressing in the upper part (20) of the kidney (16) said plurality of multi-layer lifters (1) by driving the balls and ore towards the center of the mill; and

(c) repeat the process as the mill rotates.

1. A multi-layer lifter (1) for semi-autogenous mills or SAG mills with improved durability, CHARACTERIZED in that it is made up of:
a base (3) formed by a body having a rectangular cross-section (4), which has a first straight side wall (5) and a second angled side wall (6); where an angled rectangular portion (7) emerges from the upper half of said angled wall (6), in which a trapezoidal projection (8) emerges from the lower portion of said base (3) to fit with the coatings or liners (12) of the inside of the mill;
a multi-laminar spring portion (9) that is made up of a multiplicity of curved convex sheets (10) and a bent straight portion (11) which is located under the rectangular angled portion (7) of said base (3); and
a hollow rubber body (2), located in the cavity formed by the base (3) and the convex curved sheets (10), which deforms when the multiplicity of sheets is compressed as a result of the force generated by the balls (15) and ore inside the mill.

2. A multi-layer lifter (1) according to claim 1, CHARACTERIZED in that the base (3) has at least one perforation to join the multilayer lifter (1) to the mill drum (18).

3. A multi-layer lifter (1) according to claim 1, CHARACTERIZED in that the lifters are placed side by side, thus forming a continuous line in the form of a lifter bar from the inlet of the mill to the outlet.

4. A method of operation of the multilayer lifter (1) for semi-autogenous mills or SAG mills with improved durability, CHARACTERIZED in that it comprises the stages of:
(a) compressing in the lower part (19) of the kidney (16) a plurality of multilayer lifters (1) having a multi-laminar spring portion (9) with curved convex sheets (10) over a hollow rubber body; and
(b) decompressing in the upper part (20) of the kidney (16) said plurality of multilayer lifters (1) by driving the balls and ore towards the center of the mill.
